(19) United States
(12) Patent Application Publication
(10) Pub. No.: US 2025/0164340 A1
(43) Pub. Date: May 22, 2025

(54) Liquid Leakage Detection Device

(71) Applicant: Shenzhen Envicool Technology Co., Ltd., Shenzhen (CN)

(72) Inventors: Chengsheng SONG, Shenzhen (CN); Xianwen REN, Shenzhen (CN)

(73) Assignee: Shenzhen Envicool Technology Co., Ltd., Shenzhen (CN)

(21) Appl. No.: 19/031,413

(22) Filed: Jan. 18, 2025

Related U.S. Application Data
(63) Continuation of application No. PCT/CN2024/123946, filed on Oct. 10, 2024.

(30) Foreign Application Priority Data
Oct. 13, 2023 (CN) 202311333375.5

(51) Int. Cl. G01M 3/16; G01M 3/18

(52) U.S. Cl. CPC G01M 3/165; G01M 3/182

(57) ABSTRACT

A liquid leakage detection device includes a first liquid leakage detection component and a second liquid leakage detection component. The first liquid leakage detection component includes a first flexible film insulation layer and first electrodes arranged on an inner surface of the first flexible film insulation layer. The second liquid leakage detection component includes a second flexible film insulation layer and second electrodes arranged on an inner surface of the second flexible film insulation layer. The inner surfaces of the first flexible film insulation layer and the second flexible film insulation layer are configured to cover a pipeline to be detected. The first and second electrodes are electrically connected to a detector by an electrical connector. The detector can determine whether the pipeline has liquid leakage according to detected signal change. The liquid leakage detection device realizes fast detection and can accurately detect each leakage spot in the pipeline.

The present disclosure claims priority to Chinese patent application No. 202311333375.5, entitled “Liquid Leakage Detection Device”, filed with the China National Intellectual Property Administration on Oct. 13, 2023, the entire content of which is incorporated herein by reference.

### FIELD

The present disclosure relates to the technical field of liquid leakage detection and, in particular, to a liquid leakage detection device for detecting liquid leakage in liquid cooling facilities and pipelines on a liquid-cooled data center.

### BACKGROUND

Pipelines are essential components in the process of liquid delivery, but pipeline leakage accidents occur from time to time due to reasons such as pipeline aging, climate and environmental changes, and human damage. Moreover, most pipelines are arranged inside the equipment, and the working environment of the pipelines is relatively complex.

In conventional liquid leakage detection, a water collecting tray is usually used to collect leaked liquid, and the leaked liquid is allowed to contact a sensor arranged in the water collecting tray. Only after the sensor detects a signal change, a liquid leakage alarm generates. It takes a long time to get a detection result. Once the sensor senses liquid leakage, a large amount of liquid has leaked in most cases, and it is impossible to accurately locate a specific leak spot, causing great losses.

### SUMMARY

In order to overcome the problems existing in the above prior art, it is desired to provide an improved liquid leakage detection device that has a fast detection speed and can accurately detect each leakage spot in a pipeline.

In one aspect, the present disclosure provides a liquid leakage detection device which comprises at least one first liquid leakage detection component and at least one second liquid leakage detection component. The first liquid leakage detection component comprises a first flexible film insulation layer and at least one first electrode arranged on an inner surface of the first flexible film insulation layer, and the inner surface of the first flexible film insulation layer is configured to cover a pipeline to be detected. The second liquid leakage detection component comprises a second flexible film insulation layer and at least one second electrode arranged on an inner surface of the second flexible film insulation layer, and the inner surface of the second flexible film insulation layer is configured to cover another pipeline to be detected. The first electrode and the second electrode are configured to be electrically connected to a detector by at least one electrical connector such that the detector is capable of collecting signal change from the at least one first liquid leakage detection component and the at least one second liquid leakage detection component and determining whether there is leakage according to the signal change.

In some embodiments, the first liquid leakage detection component further comprises a first flexible film circuit board and a first lead, the first flexible film circuit board is arranged on the inner surface of the first flexible film insulation layer, and the first flexible film circuit board comprises the first electrode, and the first lead is connected to one end of the first flexible film circuit board. The second liquid leakage detection component further comprises a second flexible film circuit board and a plurality of second leads, the second flexible film circuit board is arranged on the inner surface of the second flexible film insulation layer, the second flexible film circuit board comprises the second electrode, the plurality of second leads is connected to opposite ends of the second flexible film circuit board. The first lead and the second leads are configured to connect the electrical connector.

In some embodiments, the electrical connector is configured to be detachably connected to the first lead and the second leads respectively.

In some embodiments, the first flexible film circuit board further comprises a first substrate which has a first side and a second side; the at least one first electrode comprises multiple first electrodes; some of the multiple first electrodes are spaced apart and distributed on the first side in a lengthwise direction of the first substrate to form a first detection electrode row; some others of the multiple first electrodes are spaced apart and distributed on the second side in the lengthwise direction of the first substrate to form a second detection electrode row. The first electrodes in the first detection electrode row are electrically connected. The first electrodes in the second detection electrode row are electrically connected.

In some embodiments, the first flexible film circuit board further comprises a first connection line, a second connection line, a third connection line and a fourth connection line; the second connection line is electrically connected to the first electrodes in the first detection electrode row, and one end of the second connection line is electrically connected to one end of the first connection line, another end of the second connection line and another end of the first connection line are electrically connected to the first lead; and the third connection line is electrically connected to the first electrodes in the second detection electrode row, one end of the third connection line is electrically connected to one end of the fourth connection line, and another end of the third connection line and another end of the fourth connection line are electrically connected to the first lead.

In some embodiments, the second flexible film circuit board comprises a second substrate which has a first side and a second side; the at least one second electrode comprises multiple second electrodes; some of the second electrodes are spaced apart and distributed on the first side in a lengthwise direction of the second substrate to form a third detection electrode row, some of the multiple second electrodes are spaced apart and distributed on the second side in the lengthwise direction of the second substrate to form a fourth detection electrode row. The second electrodes in the third detection electrode row are electrically connected. The multiple second electrodes in the fourth detection electrode row are electrically connected.

In some embodiments, the second flexible film circuit board further comprises a fifth connection line, a sixth connection line, a seventh connection line and an eighth connection line; the sixth connection line is electrically connected to the some of the multiple second electrodes in the third detection electrode row; opposite ends of each of the sixth connection line and the fifth connection line are electrically connected to the second leads respectively; the seventh connection line is electrically connected to the some others of the multiple second electrodes in the fourth detection electrode row; and opposite ends of each of the seventh connection line and the eighth connection line are electrically connected to the second leads respectively.

In some embodiments, the first connection line and the second connection line are spaced apart and distributed on the first side of the first substrate, and the first connection line is located on an outer side of the second connection line; the third connection line and the fourth connection line are spaced apart and distributed on the second side of the first substrate, and the fourth connection line is located on an outer side of the third connection line; the fifth connection line and the sixth connection line are spaced apart and distributed on the first side of the second substrate, and the fifth connection line is located on an outer side of the sixth connection line; and the seventh connection line and the eighth connection line are spaced apart and distributed on the second side of the second substrate, and the eighth connection line is located on an outer side of the seventh connection line.

In some embodiments, the first electrodes in the first detection electrode row and the first electrodes in the second detection electrode row are alternately arranged and staggered in the lengthwise direction of the first substrate; and the second electrodes in the third detection electrode row and the second electrodes in the fourth detection electrode row are alternately arranged and staggered in the lengthwise direction of the second substrate.

In some embodiments, the first liquid leakage detection component further comprises a first adsorption member which is attached to a surface of the first flexible film circuit board away from the first flexible film insulation layer; and the second liquid leakage detection component further comprises a second adsorption member which is attached to a surface of the second flexible film circuit board away from the second flexible film insulation layer.

In another aspect, the present disclosure provides a liquid leakage detection device which comprises at least one first liquid leakage detection component and at least one second liquid leakage detection component. The first liquid leakage detection component comprises a first flexible film insulation layer and a first flexible film circuit board, an inner surface of the first flexible film insulation layer is configured to cover a pipeline to be detected, and the first flexible film circuit board is arranged on the inner surface of the first flexible film insulation layer. The second liquid leakage detection component comprises a second flexible film insulation layer and a second flexible film circuit board, an inner surface of the second flexible film insulation layer is configured to cover another pipeline to be detected, and the second flexible film circuit board is arranged on the inner surface of the second flexible film insulation layer. The first flexible film circuit and the second flexible film circuit board are connected in series or in parallel to form a liquid leakage detection circuit.

In some embodiments, the first liquid leakage detection component comprises a liquid leakage detection circuit for detecting liquid leakage and a wire-break detection circuit for detecting whether a circuit loop is broken; and the second liquid leakage detection component comprises another liquid leakage detection circuit for detecting liquid leakage and another wire-break detection circuit for detecting whether another circuit loop is broken.

In some embodiments, the first flexible film circuit board comprises a first substrate and a plurality of first electrodes, and the first substrate has a first side and a second side; some of the first electrodes are spaced apart and distributed on the first side in a lengthwise direction of the first substrate to form a first detection electrode row; some other first electrodes are spaced apart and distributed on the second side in the lengthwise direction of the first substrate to form a second detection electrode row. The first leakage detection component comprises two leakage detection circuits which are formed by the first detection electrode row and the second detection electrode row, respectively. The second flexible film circuit board comprises a second substrate and a plurality of second electrodes, and the second substrate has a first side and a second side; some of the second electrodes are spaced apart and distributed on the first side of the substrate in a lengthwise direction of the second substrate to form a third detection electrode row; some other second electrodes are spaced apart and distributed on the second side of the second substrate in the lengthwise direction of the second substrate to form a fourth detection electrode row; and the second liquid leakage detection component comprises two another leakage detection circuits which are formed by the third detection electrode row and the fourth detection electrode row, respectively.

In some embodiments, some of the first electrodes in the first detection electrode row and some others of the first electrodes in the second detection electrode row are alternately arranged and staggered in the lengthwise direction of the first substrate; and the second electrodes in the third detection electrode row and the second electrodes in the fourth detection electrode row are alternately arranged and staggered in the lengthwise direction of the second substrate.

In some embodiments, each of the first liquid leakage detection component comprises a first lead connected to one end of the first flexible film circuit board; each of the second liquid leakage detection component comprises a plurality of second leads respectively connected to opposite ends of the second flexible film circuit board; and the liquid leakage detection device further comprises an electrical connector for electrically connecting the first lead and the second leads, and the first lead and the second leads are detachably connected to the electrical connector.

In some embodiments, the first flexible film circuit board comprises a first connection line, a second connection line, a third connection line and a fourth connection line; the first connection line and the second connection line are spaced apart and distributed on the first side of the first substrate, and the first connection line and the second connection line both extend in the lengthwise direction of the first substrate; the third connection line and the fourth connection line are spaced apart and distributed on the second side of the first substrate, and the third connection line and the fourth connection line both extend in the lengthwise direction of the first substrate; the second connection line is electrically connected to the first electrodes in the first detection electrode row, and one end of the second connection line is electrically connected to one end of the first connection line, another end of the second connection line and another end of the first connection line are electrically connected to the first lead; the third connection line is electrically connected to the first electrodes in the second detection electrode row, one end of the third connection line is electrically connected to one end of the fourth connection line, another end of the third connection line and another end of the fourth connection line are electrically connected to the first lead. The second flexible film circuit board comprises a fifth connection line, a sixth connection line, a seventh connection line and an eighth connection line. The fifth connection line and the sixth connection line are spaced apart and distributed on the first side of the second substrate, and the fifth connection line and the sixth connection line both extend in the lengthwise direction of the second substrate; the seventh connection line and the eighth connection line are spaced apart and distributed on the second side of the second substrate, and the seventh connection line and the eighth connection line both extend in the lengthwise direction of the second substrate; the sixth connection line is electrically connected to the second electrodes in the third detection electrode row, opposite ends of each of the sixth connection line and the seventh connection line are electrically connected to the second leads respectively. The seventh connection line is electrically connected to the second electrodes in the fourth detection electrode row, and opposite ends of each of the seventh connection line and the eighth connection line are electrically connected to the second leads respectively.

In some embodiments, the liquid leakage detection device further comprises a detector electrically connected to an end of the liquid leakage detection circuit and configured to determine whether the pipeline to be detected has liquid leakage according to an electrical signal generated by the liquid leakage detection circuit.

In some embodiments, the first and second sides of the first flexible film insulation layer are detachably connected together such that the first flexible film insulation layer can be firmly wrapped on the pipeline to be detected; and the first and second sides of the second flexible film insulation layer are detachably connected together such that the first flexible film insulation layer can be firmly wrapped on the pipeline to be detected.

In some embodiments, the last section of the pipeline to be detected is covered with the first flexible film insulation layer, the first flexible film circuit board facing the pipeline to be detected; the middle or the first section of the pipeline to be detected is covered with the second flexible film insulation layer, the second flexible film circuit board facing the pipeline to be detected.

In a further aspect, the present disclosure provides a liquid leakage detection device which comprises at least one first liquid leakage detection component, at least one second liquid leakage detection component, an electrical connector and a detector. The first liquid leakage detection component comprises a first flexible film insulation layer and a first flexible film circuit board, an inner surface of the first flexible film insulation layer is configured to cover a pipeline to be detected, the first flexible film circuit board is arranged on the inner surface of the first flexible film insulation layer, and the first flexible film circuit board comprises at least one first electrode. The second liquid leakage detection component comprises a second flexible film insulation layer and a second flexible film circuit board, an inner surface of the second flexible film insulation layer is configured to cover another pipeline to be detected, the second flexible film circuit board is arranged on the inner surface of the second flexible film insulation layer, and the second flexible film circuit board comprises at least one second electrode. The first electrode is electrically connected to the second electrode by the electrical connector to form a liquid leakage detection circuit. The detector is electrically connected to an end of the liquid leakage detection circuit and is configured to determine whether the pipelines to be detected have liquid leakage according to an electrical signal generated by the liquid leakage detection circuit.

The liquid leakage detection device of the present disclosure has at least the following beneficial effects:

Compared with the prior art, the liquid leakage detection device of the present disclosure includes a first liquid leakage detection component and a second liquid leakage detection component, wherein the first liquid leakage detection component includes a first flexible film insulation layer and at least one first electrode arranged on an inner surface of the first flexible film insulation layer; the second liquid leakage detection component includes a second flexible film insulation layer and at least one second electrode arranged on an inner surface of the second flexible film insulation layer; the inner surfaces of the first flexible film insulation layer and the second flexible film insulation layer are usable to cover an object to be detected. The first electrode and the second electrode are electrically connected to a detector by at least one electrical connector. In detection of whether pipelines to be detected have leakage, the pipelines to be detected are respectively covered by the first liquid leakage detection component and the second liquid leakage detection component. When the pipeline to be detected covered by the first liquid leakage detection component or by the second leakage detection component has leakage, the detector collects a signal change, so as to determine whether there is leakage according to the signal change. The liquid leakage detection device realizes fast detection and can accurately detect each leakage spot in the pipelines.

### BRIEF DESCRIPTION OF THE DRAWINGS

FIG. 1 is a schematic structural diagram of a first liquid leakage detection component in a liquid leakage detection device according to an embodiment of the present disclosure.

FIG. 2 is a perspective view of the first liquid leakage detection component shown in FIG. 1 when in an installed state.

FIG. 3 is a schematic structural diagram of a second liquid leakage detection component in a liquid leakage detection device according to an embodiment of the present disclosure.

FIG. 4 is a perspective view of the second liquid leakage detection component shown in FIG. 3 when in an installed state.

FIG. 5 is a schematic circuit structure diagram of a first flexible film circuit board according to an embodiment of the present disclosure.

FIG. 6 is a schematic circuit structure diagram of a second flexible film circuit board according to an embodiment of the present disclosure.

FIG. 7 is a schematic block diagram of a liquid leakage detection device according to an embodiment of the present disclosure.

### REFERENCE NUMERALS

1. first liquid leakage detection component; 11. first flexible film insulating layer; 12. first flexible film circuit board; 121. first substrate; 121a. first side; 121b. second side; 122. first electrode; 123. first connection line; 124. second connection line; 125. third connection line; 126. fourth connection line; 13. first lead; 14. first extension portion; 2. second liquid leakage detection component; 21. second flexible film insulation layer; 22. second flexible film circuit board; 221. second substrate; 221a, first side portion; 221b. second side portion; 222. second electrode; 223, fifth connection line; 224. sixth connection line; 225. seventh connection line; 226. eighth connection line; 23. second lead; 24, second extension portion; electrical connector 3; detector 4.

### DESCRIPTION OF THE EMBODIMENTS

In order to make the objective, technical solution and advantages of the present disclosure more clearly understood, the present disclosure is further described in detail in combination with the accompanying drawings and embodiments. It should be understood that the specific embodiments described herein are only intended to explain the present disclosure but not to limit the present disclosure.

As used herein, unless otherwise expressly specified and limited, the terms “first” and “second” are used for descriptive purposes only and shall not be understood as indicating or implying relative importance. Unless otherwise specified or explained, the term “a plurality of” refers to two or more. The terms “connect”, “fix” and the like shall be understood in a broad sense, for example, “connect” may be a fixed connection, a detachable connection, an integral connection, or an electrical connection; it may be a direct connection or an indirect connection by means of an intermediate medium. For those of ordinary skill in the art, the specific meanings of the above terms in the present disclosure can be understood according to specific circumstances.

In the description of this specification, as will be appreciated, orientation defined by terms “top”, “bottom” etc., as used in the embodiments of the present disclosure, is described at the angle shown in the accompanying drawings and should not be understood as limiting the embodiments of the present disclosure. In addition, in the context, as also will be appreciated, if an element is described as being connected to the “top” or “bottom” of another element, the element can not only be directly connected to the “top” or “bottom” of another element, but also indirectly connected to the “top” or “bottom” of another element by an intermediate element.

Limited by the detection environment and reliability requirements, most of the conventional leakage detection solutions use passive detection. Only when liquid contacts a sensor and the sensor detects a signal change, a leakage alarm can be made. These solutions are more suitable for large industrial scenarios such as conventional factories, oil depots, and long-distance pipelines. When the leakage is found, even if it has happened for a while, the loss caused is also within a controllable range. This leads to lower detection requirements, but higher requirements for the durability and reliability of sensors, and the sensors need to adapt to different harsh working conditions. And because liquids to be detected in the past are generally acid and alkali liquids and other liquids with high conductivity, once liquid leakage occurs, a large amount of liquid is leaked, so detection requirements and difficulty are not high. In addition, the electromagnetic environment is relatively simple, and the sensors are less interfered.

At present, the liquid leakage detection solutions for complex working conditions pipelines (such as pipelines with small outer diameters and complex structures) are still in an immature state. The materials and structures of the pipelines are complex and diverse, and there are many types of liquids flowing in the pipelines, bringing great difficulties and challenges to the development of the detection performance and reliability of liquid leakage detection.

Current liquid leakage detection methods are as follows: 1. Leaked liquid is collected by a water collecting tray or a water receiving tray, and after a point sensor contacts the leaked liquid, the impedance changes or the electrical/optical signal changes due to the refraction of light, thus sensing the liquid leakage. 2. Liquid leakage detection using a liquid leakage sensing rope or sensing belt: This method is mainly used in a larger plane space, such as the ground, the bottom of equipment and areas along underground pipelines. Its detection principle is as follows: leaked liquid contacts a water-soaked rope, causing the impedance or capacitive reactance of a sensing cable to change. 3. Liquid leakage detection using an optical signal: When light contacts the surface of an optical fiber used for liquid leakage detection, the optical signal is refracted at a leakage spot, and the liquid leakage detection is achieved by detecting the signal change at a receiving end. 4. Liquid leakage detection based on RFID (Radio Frequency Identification System): The detection principle of this method is as follows: since the capacitive reactance of the detected liquid is significantly greater than that of air, the ultra-high frequency signal transmission will be affected by the liquid the system contacts, thus achieving liquid leakage detection.

For the first detection method described above, intensive detection can avoid false alarm interference. However, once leaked liquid is sensed, a large amount of liquid has leaked in most cases, causing great losses. So this detection method is not suitable for the current demand for liquid leakage detection. For the second detection method described above, the liquid leakage detection is based on change in impedance or capacitive reactance after the liquid contacts the sensing rope. This method features that the rope is wound on a pipeline. However, because this method requires a sensing rope having a small diameter and made of a soft material, the detection has blind spots and the installation and fixation of the sensing rope are complicated, thus affecting the detection effect. For the third detection method described above, the cost of detectors and sensors is significantly higher than that of other detection methods, and the liquid leakage detection using an optical fiber has high requirements for the installation of pipelines. For the fourth detection method described above, although wireless detection can be achieved, the current technology still has problems such as high power consumption, high cost, large interference, and low detection efficiency.

In summary, the current leakage detection methods have the following defects: the liquid leakage detection response is slow, the detection response time is long, and the probability of false alarm is high, resulting in low liquid leakage detection accuracy and poor reliability. The liquid leakage detection sensor can only cover parts with simpler structures and cannot cover all leakage spots. In other words, it is impossible to perform comprehensive liquid leakage detection and there are detection blind spots. The liquid cooling secondary side structure has small space and is not easy to install and disassemble, thereby affecting the efficiency and sensor accuracy. Currently, liquid leakage detection can only realize liquid leakage alarm, but cannot deal with liquid leakage immediately; it is difficult to find leakage spots, and maintenance and analysis take a long time; the sensor which has large electrode cannot adapt to scenarios with complex structures, and has high cost.

In the following description, an object to be detected may be a pipeline or a surface of an equipment. The following description takes a pipeline as an example of an object to be detected.

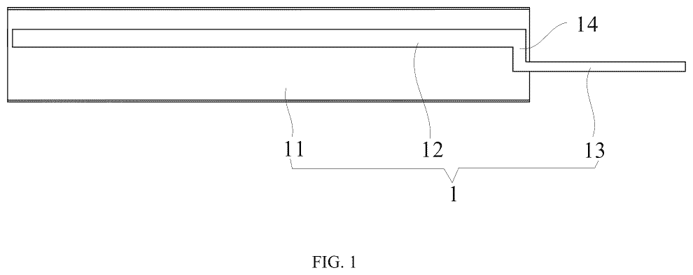

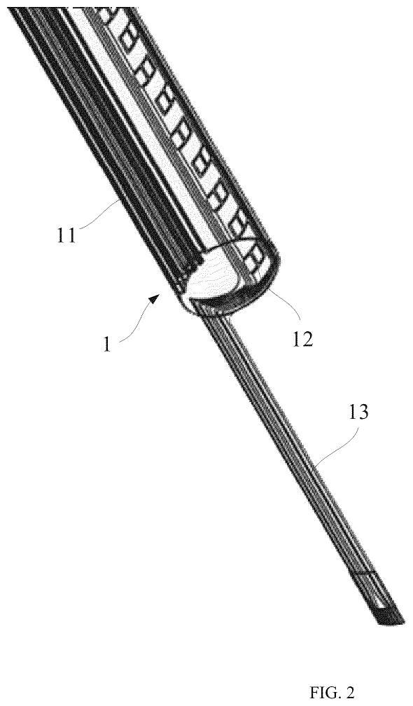

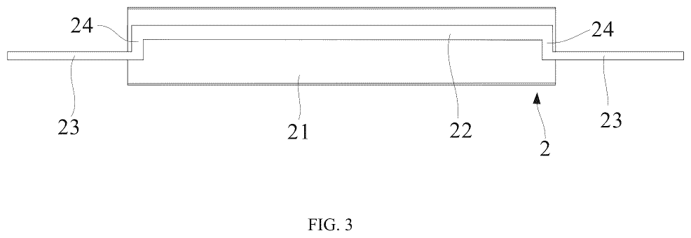

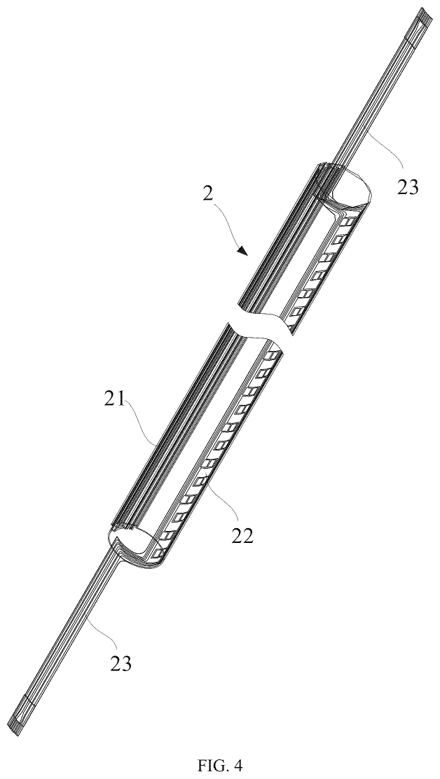

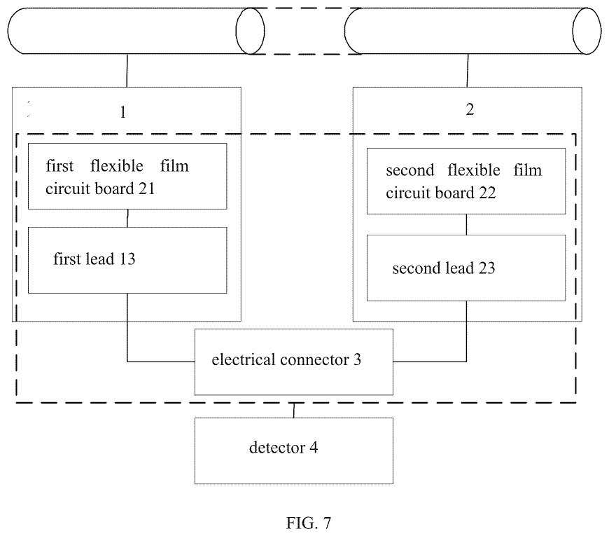

Referring to FIGS. 1-4, an embodiment of the present disclosure discloses a liquid leakage detection device. The liquid leakage detection device includes first liquid leakage detection components 1, second liquid leakage detection components 2, a detector 4 (shown in FIG. 7) and an electrical connector 3 (shown in FIG. 7). A plurality of first liquid leakage detection components 1 and a plurality of second liquid leakage detection components 2 are provided. Each first liquid leakage detection component 1 includes a first flexible film insulation layer 11, a first flexible film circuit board 12 and a first lead 13. An inner surface of the first flexible film insulation layer 11 is usable to cover a part of an object to be detected, the first flexible film circuit board 12 is arranged on the inner surface of the first flexible film insulation layer 11, and the first lead 13 is connected to one end of the first flexible film circuit board 12 to form a single-lead liquid leakage detection component. Each second liquid leakage detection component 2 includes a second flexible film insulation layer 21, a second flexible film circuit board 22 and a plurality of second leads 23. An inner surface of the second flexible film insulation layer 21 is usable to cover the object to be detected, the second flexible film circuit board 22 is arranged on the inner surface of the second flexible film insulation layer 21, and the plurality of second leads 23 are respectively connected to opposite ends of the second flexible film circuit board 22 to form a double-lead liquid leakage detection component. The electrical connector 3 is configured to electrically connect the first lead 13 and the second leads 23 to form a liquid leakage detection circuit (shown in the dotted box in FIG. 7). The detector 4 is electrically connected to an end of the liquid leakage detection circuit to determine whether a pipeline to be detected has liquid leakage according to an electrical signal generated by the liquid leakage detection circuit. The detector 4 may be a signal collector, a comparator or a controller and so on. For example, when a comparator is used as the detector 4, the comparator comprises a reference signal input terminal and another signal input terminal connected to the electrical connector 3. When a liquid leakage occurs, the signal transferred from the electrical connector 3 changes. The comparison result with the reference input signal will change, and the output of the comparator can change accordingly. In this way, it can be determined whether a liquid leakage has occurred.

Because the circuit structures of the first liquid leakage detection components 1 and the second liquid leakage detection components 2 described above are related to the application requirements, various types of circuit structures are available, but the main structures thereof are the same. The functional divisions of these circuit structures can be roughly divided into four areas: circuit connection areas at ends, a liquid leakage detection area in the middle, and an area of other circuits on the back side. For different requirements, the functional divisions may be simplified.

In actual application scenarios, a dual-circuit cold plate pipeline inside a server usually has multiple sections of pipeline in series/parallel connection. Generally, the last section of pipeline is equipped with the first liquid leakage detection component 1 (i.e., the single-lead liquid leakage detection component), and the start and middle sections of pipeline are equipped with the second liquid leakage detection components 2 (i.e., the double-lead liquid leakage detection components). That is, the last section of pipeline to be detected is covered with the first flexible film insulation layer 11, the first flexible film circuit board 12 facing the pipeline to be detected. The middle or the start section of the pipeline to be detected is covered with the second flexible film insulation layer 21, the second flexible film circuit board 22 facing the pipeline to be detected. The first flexible film circuit board 12 is electrically connected to the second flexible film circuit board 22 by the electrical connector 3. When liquid leaks from the pipeline and contacts the liquid leakage detection circuit of the first flexible film circuit board 12 or the second flexible film circuit board 22, the impedance or capacitance between the circuits changes. Thus, the signal collector can detect whether there is leakage according to the signal change. In this way, whether there is leakage in the pipeline to be detected can be detected by the first flexible film circuit board 12 and the second flexible film circuit board 22, and the leaked liquid does not flow out. The detection speed is high, and leakage spots in the pipeline can be detected more accurately, as shown in FIG. 7.

In this embodiment, for different liquid cooling components, the first liquid leakage detection component 1 and the second liquid leakage detection component 2 in the liquid leakage detection device may have different combinations, and the first liquid leakage detection component 1 and the second liquid leakage detection component 2 are connected by the electrical connector 3 to form a series or parallel leakage detection circuit to adapt to different pipeline structures, thus achieving good applicability. For example, according to different pipeline structures to be detected, one or more first liquid leakage detection component 1 and one or more second liquid leakage detection component 2 are connected together to form a liquid leakage detection circuit. A typical dual-CPU liquid cooling pipeline has three sections of pipeline, so a combination of two first liquid leakage detection components 1 and one second liquid leakage detection component 2 or a combination of two second liquid leakage detection components 2 and one first liquid leakage detection component 1 can be adopted. In this embodiment, the first flexible film circuit board 12 is connected to the first flexible film insulation layer 11 by bonding, and the second flexible film circuit board 22 is connected to the second flexible film insulation layer 21 by bonding; the first leads 13 and the second leads 23 are detachably connected to the electrical connector 3. Alternatively, in other embodiments, the first flexible film circuit board 12 may also be connected to the first flexible film insulation layer 11 by other means and the second flexible film circuit board 22 may also be connected to the second flexible film insulation layer 21 by other means, such as hot pressing. In this embodiment, because the flexible film circuit boards are connected to the flexible film insulation layers by bonding or hot pressing, the first liquid leakage detection component 1 and the second liquid leakage detection component 2 have the advantages of high strength, small thickness, good adaptability to changes in pipeline angles and dimensions, simple processing and the like.

Further, opposite longitudinal sides of the first flexible film insulation layer 11 may be detachably connected together by snap-fit, and opposite longitudinal sides of the second flexible film insulation layer 21 may be detachably connected together by snap-fit. In this embodiment, the flexible film insulation layers 11/21 are detachably covered on the pipeline, so that the liquid leakage detection components may be attached on the pipeline after the pipeline is assembled. In this way, it is flexible to attach and detach the flexible film insulation layers, the internal detection environment of the liquid leakage detection device is isolated from the external environment, and thus high reliability is achieved.

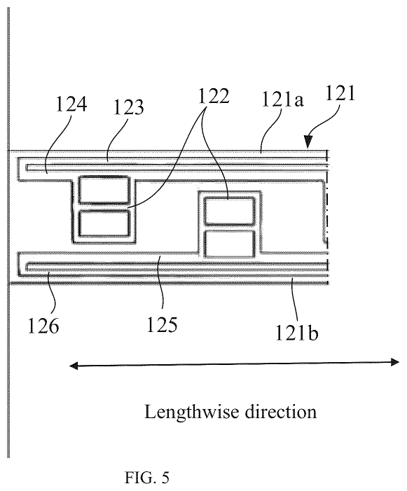

As shown in FIG. 5, the first flexible film circuit board 12 includes a first substrate 121, a first connection line 123, a second connection line 124, a third connection line 125, a fourth connection line 126 and a plurality of first electrodes 122. The first connection line 123, the second connection line 124, the third connection line 125, the fourth connection line 126 and the plurality of first electrodes 122 are respectively arranged on the first substrate 121. The first substrate 121 has a first side 121a and a second side 121b. Among the plurality of first electrodes 122, some first electrodes 122 are spaced apart and distributed on the first side 121a in a lengthwise direction of the first substrate 121 to form a first detection electrode row, and some other first electrodes 122 are spaced apart and distributed on the second side 121b in the lengthwise direction of the first substrate 121 to form a second detection electrode row. The second connection line 124 is electrically connected to the first electrodes 122 in the first detection electrode row, one end of the second connection line 124 is electrically connected to one end of the first connection line 123, the other end of the second connection line 124 and the other end of the first connection line 123 are electrically connected to the first lead 13. The third connection line 125 is electrically connected to the first electrodes 122 in the second detection electrode row, one end of the third connection line 125 is electrically connected to one end of the fourth connection line 126, the other end of the third connection line 125 and the other end of the fourth connection line 126 are electrically connected to the first lead 13, so that the first electrodes 122 are electrically connected to the detector 4 by the electrical connector 3 and the first lead 13.

Further, the first electrodes 122 in the first detection electrode row and the first electrodes 122 in the second detection electrode row are alternately arranged and staggered in the lengthwise direction of the first substrate 121. The first connection line 123 and the second connection line 124 are spaced apart and distributed on the first side 121a, the first connection line 123 and the second connection line 124 both extend in the lengthwise direction of the first substrate 121, and the first connection line 123 is located on an outer side of the second connection line 124 in a width direction of the first substrate 121. The third connection line 125 and the fourth connection line 126 are spaced apart and distributed on the second side 121b, the third connection line 125 and the fourth connection line 126 both extend in the lengthwise direction of the first substrate 121, and the fourth connection line 126 is located on an outer side of the third connection line 125 in the width direction of the first substrate 121. In this embodiment, the first connection line 123 and the second connection line 124 are arranged on one side of the first substrate 121, and the third connection line 125 and the fourth connection line 126 are arranged on the other side of the first substrate 121, so that the middle part of the first substrate 121 in the width direction of the first substrate 121 can be vacated to distribute the first electrodes 122 thereon. In this way, the layout is reasonable, the connection is more convenient, and the area of the first substrate 121 is fully utilized.

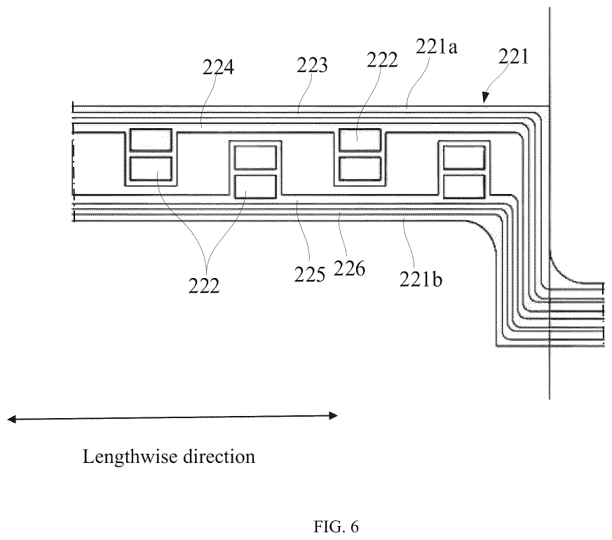

As shown in FIG. 6, the second flexible film circuit board 22 includes a second substrate 221, a fifth connection line 223, a sixth connection line 224, a seventh connection line 225, an eighth connection line 226 and a plurality of second electrodes 222. The fifth connection line 223, the sixth connection line 224, the seventh connection line 225, the eighth connection line 226 and the plurality of second electrodes 222 are respectively arranged on the second substrate 221. The second substrate 221 has a first side portion 221a and a second side portion 221b. Among the plurality of second electrodes 222, some second electrodes 222 are spaced apart and distributed on the first side portion 221a in a lengthwise direction of the second substrate 221 to form a third detection electrode row, and some second electrodes 222 are spaced apart and distributed on the second side portion 221b in the lengthwise direction of the second substrate 221 to form a fourth detection electrode row. The sixth connection line 224 is electrically connected to the second electrodes 222 in the third detection electrode row, and opposite ends of each of the sixth connection line 224 and the fifth connection line 223 are electrically connected to the second leads 23 respectively. The seventh connection line 225 is electrically connected to the second electrodes 222 in the fourth detection electrode row, and opposite ends of each of the seventh connection line 225 and the eighth connection line 226 are electrically connected to the second leads 23 respectively, so that the second electrodes 222 may be electrically connected to the detector 4 by the electrical connector 3 and the second leads 23.

Further, the second electrodes 222 in the third detection electrode row and the second electrodes 222 in the fourth detection electrode row are alternately arranged and staggered in the lengthwise direction of the second substrate 221. The fifth connection line 223 and the sixth connection line 224 are spaced apart and distributed on the first side portion 221a, the fifth connection line 223 and the sixth connection line 224 both extend in the lengthwise direction of the second substrate 221, and the fifth connection line 223 is located on an outer side of the sixth connection line 224. The seventh connection line 225 and the eighth connection line 226 are spaced apart and distributed on the second side portion 221b, the seventh connection line 225 and the eighth connection line 226 both extend in the lengthwise direction of the second substrate 221, and the eighth connection line 226 is located on an outer side of the seventh connection line 225. In this embodiment, the fifth connection line 223 and the sixth connection line 224 are arranged on one side of the second substrate 221, and the seventh connection line 225 and the eighth connection line 226 are arranged on the other side of the second substrate 221, so that the middle part of the second substrate 221 in the widthwise direction of the second substrate 221 can be vacated to distribute the second electrodes 222 thereon. In this way, the layout is reasonable, the connection is more convenient, and the area of the second substrate 221 is fully utilized.

In this embodiment, the first electrodes 122 and the second electrodes 222 both have a length of 1 mm to 10 mm and a width of 1 mm to 10 mm, a distance between two adjacent first electrodes 122 in the lengthwise direction of the first substrate 121 is between 0.5 mm and 10 mm, and a distance between two adjacent second electrodes 222 in the lengthwise direction of the second substrate 222 is between 0.5 mm and 10 mm. The first electrodes 122 and the second electrodes 222 may be subjected to gold plating or nickel plating. The first electrodes 122 and the second electrodes 222 may be shaped like rectangles, circles, stars, triangles or other shapes or combinations thereof. The number of first electrodes 122 is related to the length of the first substrate 121 and the number of second electrodes 222 is related to the length of the second substrate 221, so as to match the size of the pipeline to be detected and realize comprehensive detection.

In some embodiments, the first substrate 121 and the second substrate 221 may also be provided with detection circuits, feedback circuits, control circuits and the like for liquid leakage detection, so that the first liquid leakage detection component 1 and the second liquid leakage detection component 2 have more flexible and diverse applications.

In this embodiment, for the first liquid leakage detection component 1: two liquid leakage detection circuits are provided, namely the first detection electrode row and the second detection electrode row, for detecting liquid leakage; two wire-break detection circuits are provided, namely the first connection line 123 and the fourth connection line 126, for detecting whether the respective circuits are broken. For the second liquid leakage detection component 2: two liquid leakage detection circuits are provided, namely the third detection electrode row and the fourth detection electrode row, for detecting liquid leakage; two wire-break detection circuits are provided, namely the fifth connection line 223 and the eighth connection line 226, for detecting whether the respective circuits are broken.

Specifically, the first flexible film circuit board 12 has a 4-core single-layer pattern, including the first detection electrode row, the second detection electrode row, the first connection line 123 and the fourth connection line 126. The second flexible film circuit board 22 has a 4-core single-layer pattern, including the third detection electrode row, the fourth detection electrode row, the fifth connection line 223 and the eighth connection line 226. In special scenarios with requires for temperature, humidity or other sensor electrodes, the number of line cores and the number of layers may also be increased accordingly. For example, the first substrate 121 or the second substrate 221 may also be provided with three or more liquid leakage detection circuits, or three or more wire-break detection circuits. The above 4-core single-layer detection circuit comprises two liquid leakage detection circuits and two wire-break detection circuits, wherein the liquid leakage detection circuit and the corresponding wire-break detection circuit cooperatively form a detection loop, and two detection loops constitute a basic detection unit of the liquid leakage detection device. At the end of the first liquid leakage detection component 1, the liquid leakage detection circuits are connected to the corresponding wire-break detection circuits. For example, the second connection line 124 electrically connected to the first electrodes 122 in the first detection electrode row is electrically connected to the first connection line 123, and the third connection line 125 electrically connected to the first electrodes 122 in the second detection electrode row is electrically connected to the fourth connection line 126.

Further, the first liquid leakage detection component 1 further includes a first adsorption member, which is attached to a surface of the first flexible film circuit board 12 away from the first flexible film insulation layer 11. The second liquid leakage detection component 2 further includes a second adsorption member, which is attached to a surface of the second flexible film circuit board 22 away from the second flexible film insulation layer 21. The first adsorption member and the second adsorption member are both made of an adsorbent material having adsorption properties to a detected liquid. For example, for water, the adsorbent material may be a polymer absorbent resin, a rubber sealing strip, a woven cloth, etc. In a case of no liquid leakage, the first substrate 121 and the second substrate 221 are isolated from outer walls of the pipeline by the adsorption members to prevent false alarms. In a case of liquid leakage, the leaked liquid penetrates the first adsorption member and turns the corresponding liquid leakage detection circuit on, or the liquid penetrates the second adsorption member and turns the corresponding liquid leakage detection circuit on, thus triggering an alarm. For liquids with low conductivity, conductive characteristic signals of the circuits may be increased by the adsorption members to thereby improve the detection rate and accuracy. Furthermore, leakage gaps and pipeline gaps may be blocked by the adsorption members to slow down the liquid leakage.

In this embodiment, the first substrate 121 and the second substrate 221 are made of an insulating material, which may be one or more of TPU (thermoplastic polyurethane elastomer rubber) film, PET (polyethylene terephthalate) film, PI (polyimide) film. The first substrate 121 and the second substrate 221 both have a thickness of 0.1 mm-0.5 mm, for example, 0.1 mm, 0.2 mm, 0.3 mm, 0.4 mm or 0.5 mm. The first connection line 123, the second connection line 124, the third connection line 125, the fourth connection line 126, the fifth connection line 223, the sixth connection line 224, the seventh connection line 225 and the eighth connection line 226 are made of a pure metal such as copper, aluminum, nickel, or one or more of iron-chromium-aluminum alloys and iron-nickel-chromium alloys, or may be films or braided fabrics plated with a metal such as nickel, gold and tin, and have a thickness of 0.01 mm-1 mm.

In this embodiment, the first flexible film circuit board 12 further includes a first extension portion 14 which extends in the widthwise direction of the first substrate 121, one end of the first extension portion 14 is connected to the connection lines 123˜126, and the first lead 13 is connected to the other end of the first extension portion 14. The second flexible film circuit board 22 further includes second extension portions 24 which extend in the widthwise direction of the second substrate 221, one end of each of the second extension portions 24 is connected to the second substrate 221, and the second leads 23 are connected to the other ends of the second extension portions 24. Alternatively, in other embodiments, the first lead 13 may also be directly connected to an end of the first substrate 121, and the second leads 23 may also be directly connected to the ends of the second substrate 221. The lengths of the first lead 13 and the second leads 23 may be designed according to actual needs.

In view of the series and parallel connection of different complex multi-path pipelines, the present disclosure provides liquid leakage detection components which are matched with the pipelines, and the liquid leakage detection components and the leads are connected to the electrical connector. For a series pipeline, the present disclosure adopts a one-input one-output connection form, and for a parallel pipeline, the present disclosure adopts a one-input and multi-output connection form or a multi-input and multi-output connection form. In general, the circuits of multiple leakage detection components may be combined with the detector into one route. When there is a localization requirement for liquid leakage, each liquid leakage detection component can be connected to the detector separately through wiring and the electrical connector to meet the localization requirement.

The liquid leakage detection device of the present disclosure has the following advantages: fast leakage detection: a small amount of low-conductivity liquid can be quickly detected, and the leakage situation can be predicted; comprehensive leak detection: each internal liquid leakage risk spot and liquid leakage direction are taken into account; easy installation and maintenance: less installation and disassembly steps are involved without an adverse effect on the reliability, the detection device can be reused after the leaked liquid is wiped off, and the detection device is easy to maintain; high reliability, low probability of false alarms, and long service life; leaking stoppage: the liquid leakage detection device has a certain leaking stoppage ability, thereby giving maintenance staffs time to take response and measures and avoiding the expansion of losses; fast maintenance: the leakage spot can be shown on site such that maintenance staffs can quickly find the problem and detach the liquid leakage detection device including the liquid leakage detection components and the detector from the pipeline and remove the leaked liquid quickly, thereby shortening the maintenance time; and easy positioning of the leaking pipeline.

The above are only preferred specific embodiments of the present disclosure, but the scope of the present disclosure is not limited thereto. Any changes or substitutions that can be easily conceived by any person familiar with the art within the technical scope disclosed in the present disclosure should fall within the scope of the present disclosure. Therefore, the scope of the present disclosure should be based on the scope of the claims.

What is claimed is:

1. A liquid leakage detection device, comprising:
at least one first liquid leakage detection component, wherein the first liquid leakage detection component comprises a first flexible film insulation layer and at least one first electrode arranged on an inner surface of the first flexible film insulation layer, and the inner surface of the first flexible film insulation layer is usable to cover a part of an object to be detected; and
at least one second liquid leakage detection component, wherein the second liquid leakage detection component comprises a second flexible film insulation layer and at least one second electrode arranged on an inner surface of the second flexible film insulation layer, and the inner surface of the second flexible film insulation layer is usable to cover another part of the object to be detected;
wherein the at least one first electrode and the at least one second electrode are configured to be electrically connected to a detector by at least one electrical connector such that the detector is capable of collecting signal change from the at least one first liquid leakage detection component and the at least one second liquid leakage detection component and determining whether there is leakage according to the signal change.

2. The liquid leakage detection device according to claim 1, wherein the first liquid leakage detection component further comprises a first flexible film circuit board and a first lead, the first flexible film circuit board is arranged on the inner surface of the first flexible film insulation layer, and the first flexible film circuit board comprises the first electrode, and the first lead is connected to one end of the first flexible film circuit board;
the second liquid leakage detection component further comprises a second flexible film circuit board and a plurality of second leads, the second flexible film circuit board is arranged on the inner surface of the second flexible film insulation layer, the second flexible film circuit board comprises the second electrode, the plurality of second leads is connected to opposite ends of the second flexible film circuit board; and
the first lead and the second leads are configured to connect the electrical connector.

3. The liquid leakage detection device according to claim 2, wherein the electrical connector is configured to be detachably connected to the first lead and the second leads respectively.

4. The liquid leakage detection device according to claim 2, wherein the first flexible film circuit board further comprises a first substrate which has a first side and a second side;
the at least one first electrode comprises multiple first electrodes;
some of the multiple first electrodes are spaced apart and distributed on the first side in a lengthwise direction of the first substrate to form a first detection electrode row;
some others of the multiple first electrodes are spaced apart and distributed on the second side in the lengthwise direction of the first substrate to form a second detection electrode row;
said some of the multiple first electrodes in the first detection electrode row are electrically connected; and
said some others of the multiple first electrodes in the second detection electrode row are electrically connected.

5. The liquid leakage detection device according to claim 4, wherein the first flexible film circuit board further comprises a first connection line, a second connection line, a third connection line and a fourth connection line;
the second connection line is electrically connected to said some of the first electrodes in the first detection electrode row, and one end of the second connection line is electrically connected to one end of the first connection line, another end of the second connection line and another end of the first connection line are electrically connected to the first lead; and
the third connection line is electrically connected to said some others of the first electrodes in the second detection electrode row, one end of the third connection line is electrically connected to one end of the fourth connection line, and another end of the third connection line and another end of the fourth connection line are electrically connected to the first lead.

6. The liquid leakage detection device according to claim 5, wherein the second flexible film circuit board comprises a second substrate which has a first side and a second side;
the at least one second electrode comprises multiple second electrodes;
some of the multiple second electrodes are spaced apart and distributed on the first side in a lengthwise direction of the second substrate to form a third detection electrode row,
some others of the multiple second electrodes are spaced apart and distributed on the second side in the lengthwise direction of the second substrate to form a fourth detection electrode row,
said some of the multiple second electrodes in the third detection electrode row are electrically connected, and
said some others of the multiple second electrodes in the fourth detection electrode row are electrically connected.

7. The liquid leakage detection device according to claim 6, wherein the second flexible film circuit board further comprises a fifth connection line, a sixth connection line, a seventh connection line and an eighth connection line;
the sixth connection line is electrically connected to said some of the multiple second electrodes in the third detection electrode row;
opposite ends of each of the sixth connection line and the fifth connection line are electrically connected to the second leads respectively;
the seventh connection line is electrically connected to said some others of the multiple second electrodes in the fourth detection electrode row; and
opposite ends of each of the seventh connection line and the eighth connection line are electrically connected to the second leads respectively.

8. The liquid leakage detection device according to claim 7, wherein the first connection line and the second connection line are spaced apart and distributed on the first side of the first substrate, and the first connection line is located on an outer side of the second connection line;
the third connection line and the fourth connection line are spaced apart and distributed on the second side of the first substrate, and the fourth connection line is located on an outer side of the third connection line;
the fifth connection line and the sixth connection line are spaced apart and distributed on the first side of the second substrate, and the fifth connection line is located on an outer side of the sixth connection line; and
the seventh connection line and the eighth connection line are spaced apart and distributed on the second side of the second substrate, and the eighth connection line is located on an outer side of the seventh connection line.

9. The liquid leakage detection device according to claim 6, wherein the first electrodes in the first detection electrode row and the first electrodes in the second detection electrode row are alternately arranged and staggered in the lengthwise direction of the first substrate; and
the second electrodes in the third detection electrode row and the second electrodes in the fourth detection electrode row are alternately arranged and staggered in the lengthwise direction of the second substrate.

10. The liquid leakage detection device according to claim 2, wherein the first liquid leakage detection component further comprises a first adsorption member which is attached to a surface of the first flexible film circuit board away from the first flexible film insulation layer; and
the second liquid leakage detection component further comprises a second adsorption member which is attached to a surface of the second flexible film circuit board away from the second flexible film insulation layer.

11. A liquid leakage detection device, comprising:
at least one first liquid leakage detection component which comprises a first flexible film insulation layer and a first flexible film circuit board, an inner surface of the first flexible film insulation layer is configured to cover a pipeline to be detected, and the first flexible film circuit board is arranged on the inner surface of the first flexible film insulation layer; and
at least one second liquid leakage detection component which comprises a second flexible film insulation layer and a second flexible film circuit board, an inner surface of the second flexible film insulation layer is configured to cover another pipeline to be detected, and the second flexible film circuit board is arranged on the inner surface of the second flexible film insulation layer;
wherein the first flexible film circuit and the second flexible film circuit board are connected in series or in parallel to form a liquid leakage detection circuit.

12. The liquid leakage detection device according to claim 11, wherein the first liquid leakage detection component comprises a liquid leakage detection circuit for detecting liquid leakage and a wire-break detection circuit for detecting whether a circuit loop is broken; and
the second liquid leakage detection component comprises another liquid leakage detection circuit for detecting liquid leakage and another wire-break detection circuit for detecting whether another circuit loop is broken.

13. The liquid leakage detection device according to claim 12, wherein the first flexible film circuit board comprises a first substrate and a plurality of first electrodes, and the first substrate has a first side and a second side;
some of the first electrodes are spaced apart and distributed on the first side in a lengthwise direction of the first substrate to form a first detection electrode row;
some others of the first electrodes are spaced apart and distributed on the second side in the lengthwise direction of the first substrate to form a second detection electrode row;
the first leakage detection component comprises two said leakage detection circuits which are formed by the first detection electrode row and the second detection electrode row, respectively;
the second flexible film circuit board comprises a second substrate and a plurality of second electrodes, and the second substrate has a first side and a second side;
some of the second electrodes are spaced apart and distributed on the first side of the substrate in a lengthwise direction of the second substrate to form a third detection electrode row;
some others of the second electrodes are spaced apart and distributed on the second side of the second substrate in the lengthwise direction of the second substrate to form a fourth detection electrode row; and
the second liquid leakage detection component comprises two said another leakage detection circuits which are formed by the third detection electrode row and the fourth detection electrode row, respectively.

14. The liquid leakage detection device according to claim 13, wherein said some of the first electrodes in the first detection electrode row and said some others of the first electrodes in the second detection electrode row are alternately arranged and staggered in the lengthwise direction of the first substrate; and
said some of the second electrodes in the third detection electrode row and said some others of the second electrodes in the fourth detection electrode row are alternately arranged and staggered in the lengthwise direction of the second substrate.

15. The liquid leakage detection device according to claim 14, wherein each of the first liquid leakage detection component comprises a first lead connected to one end of the first flexible film circuit board;
each of the second liquid leakage detection component comprises a plurality of second leads respectively connected to opposite ends of the second flexible film circuit board; and
the liquid leakage detection device further comprises an electrical connector for electrically connecting the first lead and the second leads, and the first lead and the second leads are detachably connected to the electrical connector.

16. The liquid leakage detection device according to claim 15, wherein the first flexible film circuit board comprises a first connection line, a second connection line, a third connection line and a fourth connection line;
the first connection line and the second connection line are spaced apart and distributed on the first side of the first substrate, and the first connection line and the second connection line both extend in the lengthwise direction of the first substrate;
the third connection line and the fourth connection line are spaced apart and distributed on the second side of the first substrate, and the third connection line and the fourth connection line both extend in the lengthwise direction of the first substrate;
the second connection line is electrically connected to the first electrodes in the first detection electrode row, and one end of the second connection line is electrically connected to one end of the first connection line, another end of the second connection line and another end of the first connection line are electrically connected to the first lead;
the third connection line is electrically connected to the first electrodes in the second detection electrode row, one end of the third connection line is electrically connected to one end of the fourth connection line, another end of the third connection line and another end of the fourth connection line are electrically connected to the first lead;
the second flexible film circuit board comprises a fifth connection line, a sixth connection line, a seventh connection line and an eighth connection line;
the fifth connection line and the sixth connection line are spaced apart and distributed on the first side of the second substrate, and the fifth connection line and the sixth connection line both extend in the lengthwise direction of the second substrate;
the seventh connection line and the eighth connection line are spaced apart and distributed on the second side of the second substrate, and the seventh connection line and the eighth connection line both extend in the lengthwise direction of the second substrate;
the sixth connection line is electrically connected to the second electrodes in the third detection electrode row, opposite ends of each of the sixth connection line and the seventh connection line are electrically connected to the second leads respectively,
the seventh connection line is electrically connected to the second electrodes in the fourth detection electrode row, and opposite ends of each of the seventh connection line and the eighth connection line are electrically connected to the second leads respectively.

17. The liquid leakage detection device according to claim 11, wherein the liquid leakage detection device further comprises a detector electrically connected to an end of the liquid leakage detection circuit and configured to determine whether the pipeline to be detected has liquid leakage according to an electrical signal generated by the liquid leakage detection circuit.

18. The liquid leakage detection device according to claim 17, wherein the first and second sides of the first flexible film insulation layer are detachably connected together such that the first flexible film insulation layer can be firmly wrapped on the pipeline to be detected; and
the first and second sides of the second flexible film insulation layer are detachably connected together such that the first flexible film insulation layer can be firmly wrapped on the pipeline to be detected.

19. The liquid leakage detection device according to claim 17, wherein the last section of the pipeline to be detected is covered with the first flexible film insulation layer, the first flexible film circuit board facing the pipeline to be detected; the middle or the first section of the pipeline to be detected is covered with the second flexible film insulation layer, the second flexible film circuit board facing the pipeline to be detected.

20. A liquid leakage detection device, comprising:
at least one first liquid leakage detection component, wherein each first liquid leakage detection component comprises a first flexible film insulation layer and a first flexible film circuit board, an inner surface of the first flexible film insulation layer is configured to cover a pipeline to be detected, the first flexible film circuit board is arranged on the inner surface of the first flexible film insulation layer, and the first flexible film circuit board comprises at least one first electrode;
at least one second liquid leakage detection component, wherein each second liquid leakage detection component comprises a second flexible film insulation layer and a second flexible film circuit board, an inner surface of the second flexible film insulation layer is configured to cover another pipeline to be detected, the second flexible film circuit board is arranged on the inner surface of the second flexible film insulation layer, and the second flexible film circuit board comprises at least one second electrode;
an electrical connector, wherein the first electrode is electrically connected to the second electrode by the electrical connector to form a liquid leakage detection circuit; and
a detector, wherein the detector is electrically connected to an end of the liquid leakage detection circuit and is configured to determine whether the pipelines to be detected have liquid leakage according to an electrical signal generated by the liquid leakage detection circuit.
